(19) United States
(12) Patent Application Publication
(10) Pub. No.: US 2008/0216980 A1
(43) Pub. Date: Sep. 11, 2008

(54) PAPER MACHINE BELT WITH WATER IMPERMEABLE BASE LAYER AND POROUS SURFACE

(76) Inventor: Johan Malmqvist, Katrineholm (SE)

Correspondence Address: TAYLOR & AUST, P.C., P.O. Box 560, 142. S Main Street, Avilla, IN, 46710, US

(21) Appl. No.: 11/683,707

(22) Filed: Mar. 8, 2007

(51) Int. Cl. B31F 1/00; B32B 3/26; B32B 7/12

(52) U.S. Cl. 162/287; 428/304.4; 428/317.1; 428/318.4

(57) ABSTRACT

A belt for use in a paper machine includes a water impermeable base layer and a web-side porous layer coupled with the base layer. The porous layer includes interconnected pores which are of an open cell structure.

### BACKGROUND OF THE INVENTION

1. Field of the Invention

The present invention relates to transfer belts for a paper machine, and, more particularly, to transfer belts with a porous surface.

2. Description of the Related Art

A papermachine typically includes multiple sections, such as a forming section, press section, drying section, etc. Each section has at least one endless clothing, configured for the particular section of the paper machine, which carries a fiber web through the machine section. At the end of each section, the fiber web is separated from the clothing and transferred to the next downstream section.

In a press section it is common to use an endless belt to carry the fiber web through one or more presses, such as a roll press, shoe press, etc. A transfer belt can sometimes hold the fiber web too good. This results in “sheet stealing” of the fiber web between sections and the fiber web does not follow the correct path through the paper machine, which of course is not desirable.

It is known to provide a transfer belt with an impermeable base layer and porous surface layer for improved sheet release and improved sheet transfer. The porous surface layer is formed with “blind” pores which are not fluidly interconnected together. Water which is trapped within the pores thus cannot flow laterally through other pores to disperse throughout the porous layer.

What is needed in the art is a belt for a paper machine with good sheet release which does not sheet steal the fiber web and allows efficient and reliable sheet transfer from one section to another in the paper machine.

### SUMMARY OF THE INVENTION

The present invention provides a belt with a water impermeable base layer and porous surface layer, optionally with a strength layer therebetween.

The invention in one form is directed to a belt for use in a paper machine, including a water impermeable base layer and a web-side porous layer coupled with the base layer. The porous layer includes interconnected pores which are of an open cell structure.

An advantage of the present invention is good sheet transfer of the fiber web.

Another advantage is that the fiber web is not substantially rewetted after a pressing operation.

Yet another advantage is that the porous layer can optionally be reinforced with fibers or particles.

A further advantage is that a strength layer can be used to interconnect the base layer and porous layer, providing dimensional stability to the belt.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic illustration of a portion of a paper-making machine including an embodiment of a belt of the present invention;

FIG. 2 is a side, sectional view of a portion of the belt shown in FIG. 1; and

FIG. 3 is a side, sectional view of a portion of another embodiment of a belt of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

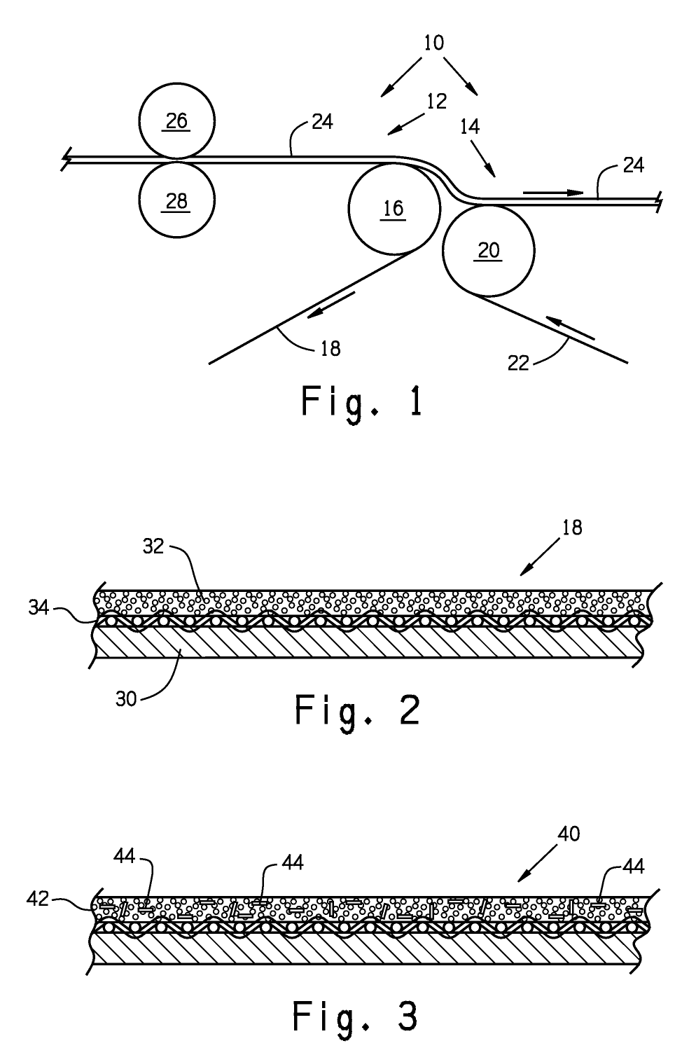

Referring now to the drawings, and more particularly to FIG. 1, there is shown a portion of a paper-making machine 10, including a portion of a press section 12 and a drying section 14. Press section 12 includes a downstream roll 16 which carries a belt 18 of the present invention. Similarly, an upstream roll 20 of drying section 14 carries a felt 22. A fiber web 24, such as a paper, tissue or board web, is carried by each of belt 18 and felt 22, and is transferred between upstream roll 16 and downstream roll 20 generally in a manner as shown. It will be appreciated that many different roll and sheet transfer configurations are possible.

Press section 12 also includes a pair of press rolls 26 and 28 which are positioned upstream from roll 16. Press rolls 26 and 28 exert a pressing action on each of fiber web 24 and belt 18. The pressing action is intended to squeeze water out of fiber web 24 and into belt 18. Press section 12 may include other types of presses and/or multiple presses.

As is apparent from FIG. 1, fiber web 24 must separate from belt 18 for sheet transfer between press section 12 and drying section 14. A thin water film is developed between fiber web 24 and belt 18 as a result of the pressing action by press rolls 26 and 28. This thin water film ensures that belt 18 carries fiber web 24 to the transfer point at the downstream end of press section 12 (principally through adhesion and cohesion properties). However, belt 18 must also have good sheet release properties so that fiber web 24 can be transferred to the downstream drying section 14 without sheet stealing, which would likely result in breakage of fiber web 24 at the sheet transfer location.

Referring now to FIG. 2, belt 18 will be described in greater detail hereinafter. In general, belt 18 includes a water impermeable base layer 30, a web side porous layer 32, and an intermediate strength layer 34 interconnecting porous layer 32 with base layer 30.

Base layer 30 is constructed from a material which is resilient and waterproof, such as an elastomer, polymer and/or plastic composition. Base layer 30 can include a hydrophobic material which repels water, such as polytetrafluoroethylene (e.g., Teflon®). The hydrophobic material could be coated on or mixed with base layer 30.

Porous layer 32 is coupled with base layer 30, either directly or through optional strength layer 34. Porous layer 32 includes interconnected pores which are of an open cell structure (the terms “cell” and “pore” are used synonymously herein). The open cell structure means that most of the pores are in fluid communication with each other, although it is possible that on a random basis some of the pore walls may define closed pores which are not in fluid communication with other pores. For example, porous layer 32 may be in the form of an open cell foam structure. An open cell foam is defined by the McGraw-Hill Dictionary Of Scientific and Technical Terms, 5^{th} Edition, as a “foamed material, natural or synthetic, rigid or flexible, organ or metallic, in which there is interconnection between the cells.” This definition of an open cell foam broadly captures the open cell arrangement of porous layer 32; however, other types of open cell structures besides an open cell foam are also possible and within the scope of this invention.

As belt 18 is pressed between press rolls 26 and 28, porous layer 32 is compressed. As belt 18 leaves the press nip between press rolls 26 and 28, porous layer 32 expands and absorbs some of the water which is pressed from fiber web 24 in the press nip. Porous layer 32 has a water carrying capacity which is sufficient to accomplish this absorption of the water such that a thin film of water exists between fiber web 24 and belt 18 at the downstream side of the press nip, while at the same time still providing good sheet release for transfer to the downstream section of the paper machine 10. More particularly, porous layer 32 has a water carrying capacity of between approximately 0.001 to 0.09 milliliters per cubic centimeter; preferably a water carrying capacity of between approximately 0.01 to 0.9 milliliters per cubic centimeter; and more preferably a water carrying capacity of approximately 0.05 milliliters per cubic centimeter.

Porous layer 32 has a porosity corresponding to the water carrying capacity identified above. In particular, porous layer 32 has a porosity of between approximately 10 to 10,000 pores per cubic centimeter; preferably a porosity of between approximately 100 to 10,000 pores per cubic centimeter; and more preferably a porosity of approximately 1000 pores per cubic centimeter.

Porous layer 32 may be sintered together, and preferably does not include a filler within the pores.

Intermediate strength layer 34 interconnects porous layer 32 with base layer 30, as indicated above. In the embodiment shown in FIG. 2, strength layer 34 is in the form of woven yarns which extend in both the machine direction (MD) and cross machine direction (CD). Other types of strength layers providing dimensional stability to belt 18 are also possible. For example, strength layer 34 can be in the form of one or more steel bands extending in the MD direction and/or CD direction of belt 18. Strength layer 34 could also be in the form of a reinforced polymer matrix or at least one non-woven fibrous mat. Strength layer 34 may also optionally include a fiber batt. Strength layer 34 may be coupled with base layer 30 and porous layer 32 by an adhesive, chemical bonding and/or melting. Other coupling mechanisms between strength layer 34, porous layer 32 and base layer 30 are also possible.

Referring now to FIG. 3, a portion of another embodiment of a belt 40 of the present invention is shown. Belt 40 shown in FIG. 3 is similar to belt 18 shown in FIG. 2, with the primary difference being that porous layer 42 is reinforced with fibers 44, such as fiberglass or carbon fibers. Porous layer 42 can also be reinforced with other types of reinforcement, such as particles (not shown).

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claim

What is claimed is:

1. A belt for use in a paper machine, comprising:
a water impermeable base layer; and
a web-side porous layer coupled with said base layer, said porous layer including interconnected pores, said pores being of an open cell structure.

2. The belt of claim 1, wherein said porous layer has a porosity of between approximately 10 to 10,0000 pores per cubic centimeter.

3. The belt of claim 2, wherein said porous layer has a porosity of between approximately 100 to 10,000 pores per cubic centimeter.

4. The belt of claim 3, wherein said porous layer has a porosity of approximately 1000 pores per cubic centimeter.

5. The belt of claim 1, wherein said porous layer has a water carrying capacity of between approximately 0.001 to 0.9 milliliters per cubic centimeter.

6. The belt of claim 5, wherein said porous layer has a water carrying capacity of between approximately 0.01 to 0.09 milliliters per cubic centimeter.

7. The belt of claim 6, wherein said porous layer has a water carrying capacity of approximately 0.05 milliliters per cubic centimeter.

8. The belt of claim 1, wherein said porous layer comprises at least one of fibers and particles.

9. The belt of claim 8, wherein said porous layer is sintered together.

10. The belt of claim 1, wherein said porous layer does not include a filler in said pores.

11. The belt of claim 1, wherein said base layer is hydrophobic.

12. The belt of claim 1, including an intermediate strength layer interconnecting said porous layer with said base layer.

13. The belt of claim 12, wherein said intermediate strength layer comprises one of:
yarns extending in at least one of a machine direction and a cross machine direction;
at least one steel band extending in at least one of said machine direction and said cross machine direction;
a reinforced polymer matrix; and
at least one non-woven fibrous mat.

14. The belt of claim 13, wherein said intermediate strength layer includes fiber batt.

15. The belt of claim 12, wherein said intermediate strength layer is coupled with said base layer by at least one of an adhesive, chemical bonding, and melting.

16. The belt of claim 12, wherein said intermediate strength layer is coupled with said porous layer by at least one of an adhesive, chemical bonding, and melting.

17. A paper-making machine, comprising:
at least one roll; and
a belt carried by said roll, said belt including:
a water impermeable base layer; and
a web-side porous layer coupled with said base layer, said porous layer including interconnected pores, said pores being of an open cell structure.

18. A belt for use in a paper machine, comprising:
a water impermeable base layer;
a web-side porous layer coupled with said base layer, said porous layer including pores of an open cell structure which are substantially fluidly interconnected together; and
an intermediate strength layer interconnecting said porous layer with said base layer.

19. The belt of claim 18, wherein said porous layer has a porosity of between approximately 10 to 10,0000 pores per cubic centimeter.

20. The belt of claim 19, wherein said porous layer has a porosity of between approximately 100 to 10,000 pores per cubic centimeter.

21. The belt of claim 20, wherein said porous layer has a porosity of approximately 1000 pores per cubic centimeter.

22. The belt of claim 18, wherein said porous layer has a water carrying capacity of between approximately 0.001 to 0.9 milliliters per cubic centimeter.

23. The belt of claim 22, wherein said porous layer has a water carrying capacity of between approximately 0.01 to 0.09 milliliters per cubic centimeter.

24. The belt of claim 23, wherein said porous layer has a water carrying capacity of approximately 0.05 milliliters per cubic centimeter.

25. The belt of claim 18, wherein said porous layer comprises at least one of fibers and particles.

26. The belt of claim 25, wherein said porous layer is sintered together.

27. The belt of claim 18, wherein said porous layer does not include a filler in said pores.

28. The belt of claim 18, wherein said base layer is hydrophobic.

29. The belt of claim 18, wherein said intermediate strength layer comprises one of:
yarns extending in at least one of a machine direction and a cross machine direction;
at least one steel band extending in at least one of said machine direction and said cross machine direction;
a reinforced polymer matrix; and
at least one non-woven fibrous mat.

30. The belt of claim 29, wherein said intermediate strength layer includes fiber batt.

31. The belt of claim 18, wherein said intermediate strength layer is coupled with said base layer by at least one of an adhesive, chemical bonding, and melting.

32. The belt of claim 18, wherein said intermediate strength layer is coupled with said porous layer by at least one of an adhesive, chemical bonding, and melting.
